(19) United States
(12) Patent Application Publication
(10) Pub. No.: US 2005/0024881 A1
(43) Pub. Date: Feb. 3, 2005

(54) Shade structure of lamps

(76) Inventor: Jack Lin, Taoyuan Hsien (TW)

Correspondence Address: Yi-Wen Tseng, 509 ROOSEVELT BLVD. #D306, FALL CHURCH, VA, 22044, US

(21) Appl. No.: 10/629,688

(22) Filed: Jul. 30, 2003

(51) Int. Cl. F21V 11/00

(52) U.S. Cl. 362/351

(57) ABSTRACT

A shade structure of the lamps includes a housing, a cover plate, a light reflecting mask and a light source. The housing includes a threaded hollow column, a socket and an opening for receiving the cover plate. The cover plate is made of a transparent material. There are a plurality of protrusions formed on the edge of the cover plate for engaging with the corresponding cavities formed on the edge of the opening. The light reflecting mask includes a plurality of slots and a fixing hole with respect to the threaded hollow column of the housing so that the light reflecting mask can be combined with the housing by a fixing device and located beneath the opening. As such, when the light source emits light to the light reflecting mask, some light can pass through the slots to emit on a transparent cover plate. Therefore, a splendid lighting effect can be achieved and a delicate and gorgeous desk lamp can be obtained.

### BACKGROUND OF THE INVENTION

The present invention relates generally to a shade structure of a lamp and, more particularly, to a delicate and gorgeous desk lamp with an improved shade structure to obtain a splendid lighting effect when a light source emits light to the shade.

The lamps are widely used in our daily life. The style and appearance of the lamp is diversified in modern design. The requirement of the lamp is not only regarded as a lighting device but also a decoration offering the beauty and comfort to our living environment.

On the other hand, conventional desk lamp is designed to provide light on desk area of a room, that is, it normally cannot be used to illuminate the room; therefore, an extra lighting device is always necessary. As such, the energy cannot be saved.

Therefore, there exist inconvenience and drawbacks for practically application of the above-mentioned conventional desk lamp. There is thus a substantial need to provide an improved shade structure of the desk lamp that resolves the above drawbacks and can be used more conveniently and practically.

### BRIEF SUMMARY OF THE INVENTION

The object of the present invention is to provide a shade structure of the lamps. A light reflecting mask of the shade structure includes a plurality of slots which can be strip-shaped or circle-shaped, etc. When a light source emits light to the light reflecting mask, some light can pass through various slots to emit on a transparent cover plate. Therefore, a splendid lighting effect can be achieved and a delicate and gorgeous desk lamp can be obtained.

Another object of the present invention is to provide a shade structure of the lamps, wherein the light can emit to the cover plate of the shade structure to illuminate the room; therefore, an extra lighting device is not always necessary. As such, the energy can be saved.

In order to achieve the above-mentioned objects, the shade structure of the lamps includes a housing, a cover plate, a light reflecting mask and a light source. The housing includes a threaded hollow column, a socket and an opening for receiving the cover plate. The cover plate is made of a transparent material. There are a plurality of protrusions formed on the edge of the cover plate for engaging with the corresponding cavities formed on the edge of the opening. The light reflecting mask includes a plurality of slots and a fixing hole with respect to the threaded hollow column of the housing so that the light reflecting mask can be combined with the housing by a fixing device and located beneath the opening.

### BRIEF DESCRIPTION OF THE DRAWINGS

These, as well as other features of the present invention, will become more apparent upon reference to the drawings wherein:

FIG. 1 shows an exploded view of a shade structure of a lamp according to the present invention;

FIG. 2 shows a perspective view of the assembly of the shade structure;

FIG. 3 shows a cross-sectional view of the assembled shade structure;

FIG. 4 shows a lateral view of the assembled lamp according to the present invention;

FIG. 5 shows a top view of the assembled shade; and

FIG. 6 shows a top view of the assembled shade according to another preferred embodiment of the present invention.

### DETAILED DESCRIPTION OF THE INVENTION

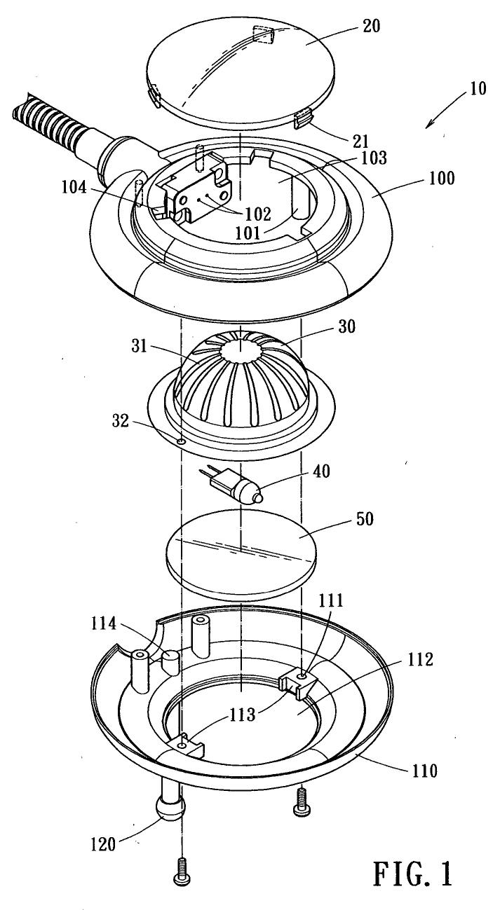

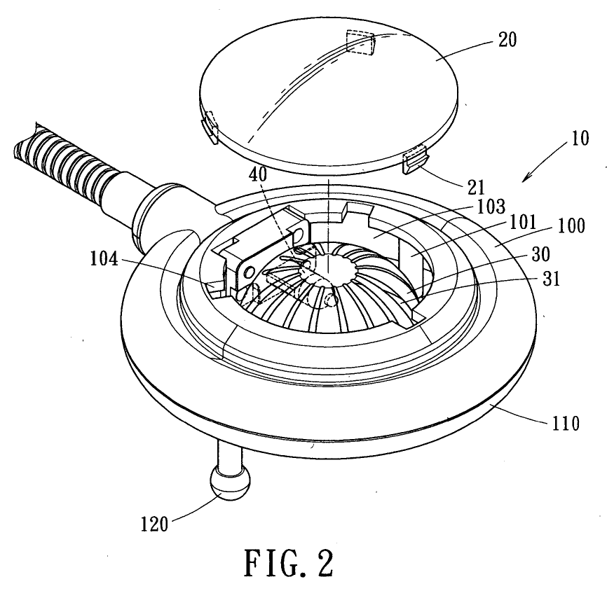

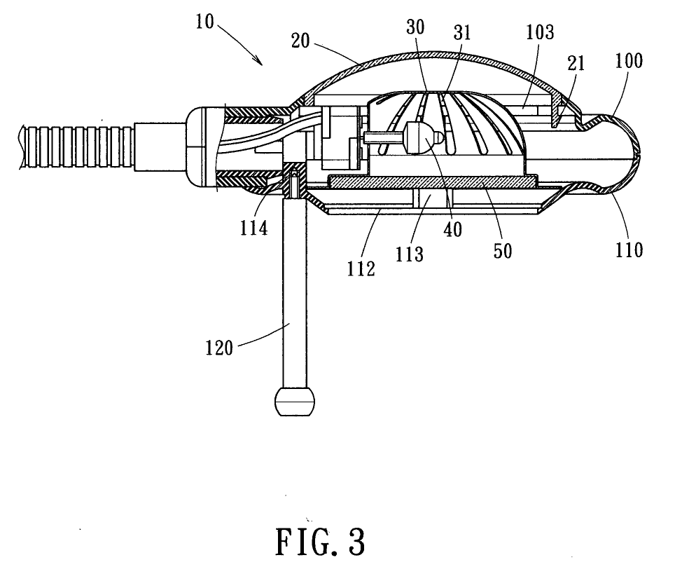

Referring to FIGS. 1-3, an improved shade structure of a desk lamp of a preferred embodiment includes a shade housing 10, a cover plate 20, a light reflecting mask 30, a light source 40 and a protecting plate 50 according to the present invention.

The shade housing 10 is combined by an upper case 100 and a bottom case 110. In another embodiment, the shade housing 10 can be formed as an integral body. The upper case 100 includes a threaded hollow column 101 and a socket 102. The socket 102 is connected with a power cord (not shown). The upper case 100 further includes a first opening 103 substantially located on the central portion thereof. There are a plurality of cavities 104 formed on the edge of the first opening 103. The bottom case 110 includes a through hole 111 with respect to the threaded hollow column 101, and a second opening 112 with respect to the first opening 103. There is an extended portion 113 formed on the edge of the second opening 112.

The cover plate 20 is made of a transparent material, and has a curved shape correspondent to the outline of the shade housing 10. There are a plurality of protrusions 21 formed on the edge of the cover plate 30 for engaging with the corresponding cavities 104 on the first opening 103 so that the cover plate 30 can be fixedly secured on the first opening 103 of the uppercase 100.

The light reflecting mask 30 is a substantially semicircle-shaped shell, which is located beneath the first opening 103 of the upper case 100. A plurality of slots 31 are formed on the light reflecting mask 30. The slots 31 can be the strip-shaped slots as shown in this preferred embodiment. There is a fixing hole 32 formed on the edge of the light reflecting mask 30. The fixing hole 32 with respect to the threaded hollow column 101 and the through hole 111 are for a fixing device, such as a screw, to combined the light reflecting mask 30 between the upper case 100 and the bottom case 110.

The light source 40 provides the light, which is plugged in the socket 102 of the upper case 100. The protecting plate 50 is a transparent circular plate to be fixed on the second opening 112 of the bottom case 110 by the extended portion 113.

When the desk lamp turns on, the light source 40 emits the light to the light reflecting mask 30. The light can further emit through the slots 31 of the light reflecting mask 30 to the cover plate 20. Therefore, it can provide a splendid lighting effect and more illumination in the room.

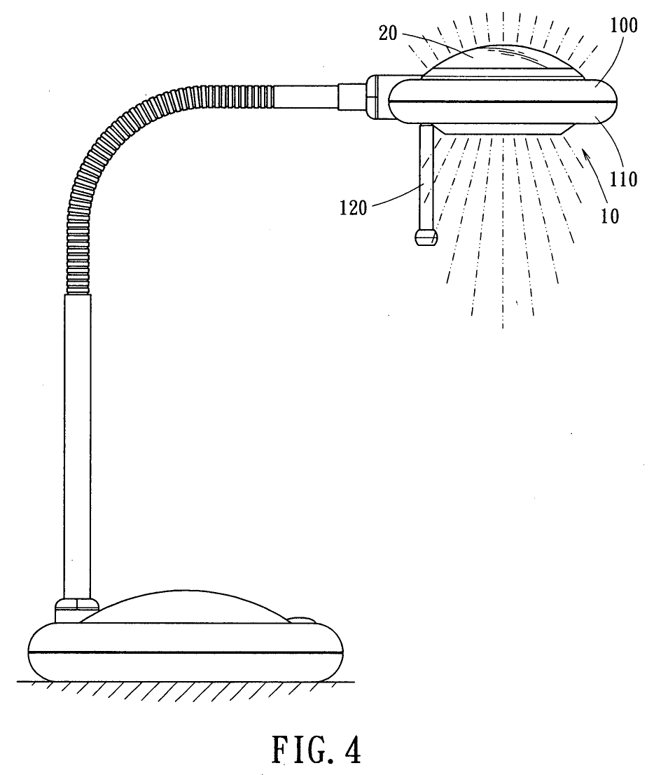

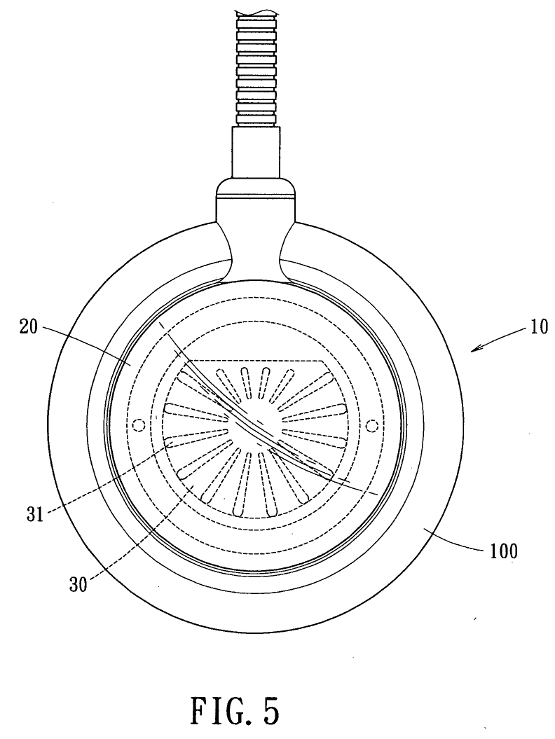

FIGS. 4 and 5 show a lateral and a top view of the assembled desk lamp, respectively, according to the present invention. There are various kinds of the light source 40. As a tungsten-halogen lamp is used in this preferred embodiment, the light source 40 will generate a pretty high temperature so that the housing 10 will be very hot. Therefore, it will be inconvenient to adjust the direction of the light directly via the housing 10. To solve this problem, a connecting portion 114 is formed on the bottom case 110 for connecting an adjusting rod 102 made of a less conductive material. As such, it is convenient for the user to utilize the adjusting rod 102 to change the position of the housing 10 so as to adjust the illuminating direction of the present desk lamp.

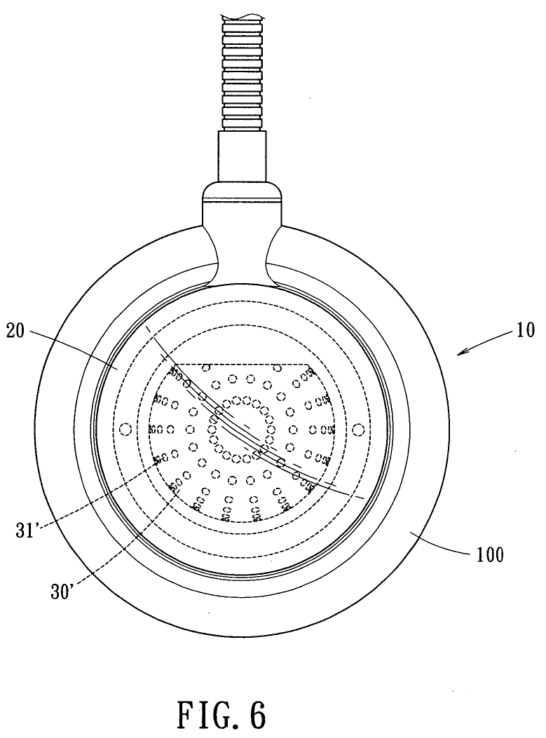

Furthermore, as shown in FIG. 6, a light reflecting mask 30′ includes a plurality of circular slots 31′ according to another embodiment of the present invention. Similarly, when the desk lamp turns on, the light source 40 emits the light to the light reflecting mask 30′. The light can further emit through the slots 31′ of the light reflecting mask 30 to the cover plate 20. Therefore, it can also provide a splendid lighting effect and more illumination in the room.

According to the shade structure of the lamps of the present invention, it provides at least the advantages as follows.

1. The light reflecting mask of the shade structure includes lots of slots which can be strip-shaped or circle-shaped, etc. When a light source emits light to the light reflecting mask, some light can pass through the various slots to emit on a transparent cover plate. Therefore, a splendid lighting effect can be achieved and a delicate and gorgeous desk lamp can be obtained.

2. The light emitting to the cover plate can illuminate the room; therefore, an extra lighting device is not always necessary. As such, the energy can be saved.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A shade structure of a lamp, comprising:
a housing including an opening;
a cover plate made of a transparent material, being mounted on the opening;
a light reflecting mask including a plurality of slots, being mounted inside the housing and located beneath the opening; and
a light source mounted inside the housing for emitting light to the light reflecting mask so that the light can emit through the slots to the cover plate.

2. The shade structure of claim 1, wherein the housing includes a plurality of cavities formed on the edge of the opening, the cover plate includes a plurality protrusions to be engaged with the cavities so that the cover plate can be fixedly secured on the opening, and the light reflecting mask includes a fixing hole with respect to the thread hollow column so that the light reflecting mask can be mounted to the housing by a fixing device.

3. The shade structure of claim 2, wherein the housing includes a connecting portion for connecting an adjusting rod so that the position of the housing can be change thereby.

4. The shade structure of claim 2, wherein fixing device is a screw.

5. The shade structure of claim 1, wherein the housing includes an upper case and a bottom case, the upper case includes the opening with a plurality of cavities formed on the edge thereof and the threaded hollow column, the bottom case includes a through hole with respect to the threaded hollow, the cover plate includes a plurality protrusions to be engaged with the cavities so that the cover plate can be fixedly secured on the opening, and the light reflecting mask includes a fixing hole with respect to the thread hollow column and the through hole so that the light reflecting mask can be mounted between the upper and the bottom case by a fixing device.

6. The shade structure of claim 5, wherein the bottom case includes a connecting portion for connecting an adjusting rod so that the position of the housing can be change thereby.

7. The shade structure of claim 1, wherein the slots are strip-shaped.

8. The shade structure of claim 1, wherein the slots are circle-shaped.
